(19) United States
(12) Patent Application Publication
(10) Pub. No.: US 2009/0132305 A1
(43) Pub. Date: May 21, 2009

(54) REGULATORY COMPLIANCE SYSTEM AND METHODOLOGY FOR PAYDAY LOANS

(75) Inventor: Nathan Groff, Jacksonville, FL (US)

Correspondence Address: MARK YOUNG, P.A., 12086 FORT CAROLINE ROAD, UNIT 202, JACKSONVILLE, FL, 32225, US

(73) Assignee: VERITEC SOLUTIONS, LLC, Jacksonville, FL (US)

(21) Appl. No.: 11/941,972

(22) Filed: Nov. 19, 2007

(51) Int. Cl. G06Q 10/00

(52) U.S. Cl. 705/7

(57) ABSTRACT

A computer-implemented method for deferred presentment transaction legal compliance includes creating a user account for a user; providing a source of law data applicable to deferred presentment transactions by the user; receiving deferred presentment transaction data for a transaction by the user; automatically comparing the deferred presentment transaction data for the transaction by the user with the law data applicable to the deferred presentment transaction by the user; and determining whether the deferred presentment transaction data for the transaction by the user complies with the law data applicable to the deferred presentment transaction by the user. A computer-implemented system for deferred presentment transaction legal compliance includes a module for creating a user account for a user; a module for providing a source of law data applicable to deferred presentment transactions by the user; a module for receiving deferred presentment transaction data for a transaction by the user; a module for automatically comparing the deferred presentment transaction data for the transaction by the user with the law data applicable to the deferred presentment transaction by the user; and a module for determining whether the deferred presentment transaction data for the transaction by the user complies with the law data applicable to the deferred presentment transaction by the user.

### FIELD OF THE INVENTION

This invention generally relates to deferred presentment transactions, and more particularly, to an automated system and method for determining whether a transaction complies with then-current applicable laws and regulations, notifying a lender of the outcome of the determination and maintaining a database of transaction information.

### BACKGROUND

Many individuals, particularly low-wage earners, rely very heavily upon check cashing services to process their paychecks and cash advance services to manage their finances. Businesses that provide such services are an extremely valuable resource to consumers with limited liquidity and access to conventional banks. For millions of consumers, these services are a way of life. Consequently, the number of outlets offering these types of services has grown dramatically in recent years. People in need have turned such outlets into a kind of alternative banking sector.

While these outlets fill a void, they suffer several shortcomings. For example, such outlets are labor-intensive and susceptible to human error. Heretofore, outlets have struggled with monitoring and interpreting applicable laws and regulations and applying the rules to transactions. Under the status quo, monitoring is typically ad hoc, interpretations are varied, and compliance is spotty at best.

Regulation of such lending institutions is handled primarily by individual states, and the growing payday loan industry is perched atop an active and shifting legal landscape. Lenders lobby to enable payday lending practices, while opponents of the industry lobby to prohibit the high cost loans in the name of consumer protection. The applicable governing laws vary widely from state to state, with some states banning such lending transactions while other states have chosen to limit and regulate them.

When not explicitly banned, laws that prohibit payday lending are usually in the form of usury limits, i.e., transaction fee caps. Some states have laws limiting the number of loans a borrower can take at a single time. Some states also cap the number of loans per borrower per year, or require that after a fixed number of loan-renewals or consecutive loans, the lender must offer a lower interest loan with a longer term or provide a waiting period, so that the borrower can eventually get out of the debt cycle. Some borrowers attempt to circumvent these laws by taking loans from more than one lender. Further complicating the lender's job, these limitations are in a state of flux, frequently changing along with associated reporting and record keeping requirements. The ever changing regulations and lack of centralization (i.e., lack of a centralized database) make it difficult or impossible for lending staff to comply with the laws and regulations.

The invention is directed to overcoming one or more of the problems and solving one or more of the needs as set forth above.

### SUMMARY OF THE INVENTION

As used herein, the term “transaction” is used to broadly cover any deferred presentment transaction, including, but not limited to payday loan and cash advance transactions. Additionally, as used herein, the terms “laws” and “regulations” broadly mean any cases, statutes, regulations, ordinances, rules, executive orders and other legal obligations and restrictions imposed by a governing body. Furthermore, the term “regulatory compliance” means the acting according to applicable laws and regulations.

To overcome one or more of the problems and solve one or more of the needs as set forth above, a computer-implemented method for deferred presentment transaction legal compliance is provided. An exemplary method includes creating a user account for a user; providing a source of law data applicable to deferred presentment transactions by the user; receiving deferred presentment transaction data for a transaction by the user; automatically comparing the deferred presentment transaction data for the transaction by the user with the law data applicable to the deferred presentment transaction by the user; and determining whether the deferred presentment transaction data for the transaction by the user complies with the law data applicable to the deferred presentment transaction by the user. The step of providing a source of law data applicable to deferred presentment transactions by the user may include reviewing a source of law data, determining and encoding requirements from the law data, including a transaction fee limit and a number of loans (i.e., number of transactions) limit. The step of providing a source of law data may include associating law data with a state identifier and storing the law data and state identifier. The step of providing a source of law data may include periodically reviewing the law data. A history table of updates to the law data may be maintained. The step of creating a user account for a user may include receiving and storing lender information input from a user, the lender information including facility identification information. Ownership entity and facility identification information (e.g., the state(s) in which the owner entity and lending facility are located) is associated with deferred presentment transaction data for the transaction, thus enabling the governing state law to be determined. The deferred presentment transaction data includes borrower information, a transaction type datum, owner entity information, lender facility location information, a transaction date, a transaction amount, a transaction fee, an agreement date, a due date, a deposit date, a closed date, a return date and other fields as required to effectively ensure that the transaction complies with applicable law. Applicable legal requirements are determined based upon the deferred presentment transaction data, particularly facility location information. The step of automatically comparing the deferred presentment transaction data for the transaction by the user with the law data applicable to the deferred presentment transaction includes comparing transaction data for the deferred presentment transaction with a maximum allowable transaction data, and/or comparing a deferred presentment transaction number for a borrower with a maximum legal number of deferred presentment transactions for a borrower, and/or comparing the deferred presentment transaction data for the transaction by the user with the law data applicable to the deferred presentment transaction includes comparing a deferred presentment transaction number for a borrower for a determined period of time with a maximum legal number of deferred presentment transactions for a borrower for a determined period of time. An approval determination is based upon the comparison of the deferred presentment transaction data for the transaction by the user with the law data applicable to the deferred presentment transaction by the user, with the determination being approved if the deferred presentment transaction data complies with the law data applicable to the deferred presentment transaction and the determination being failed if the deferred presentment transaction data complies with the law data applicable to the deferred presentment transaction.

To overcome one or more of the problems and solve one or more of the needs as set forth above, a computer-implemented system for deferred presentment transaction legal compliance is provided. An exemplary system includes a module for creating a user account for a user; a module for providing a source of law data applicable to deferred presentment transactions by the user; a module for receiving deferred presentment transaction data for a transaction by the user; a module for automatically comparing the deferred presentment transaction data for the transaction by the user with the law data applicable to the deferred presentment transaction by the user; a module for determining whether the deferred presentment transaction data for the transaction by the user complies with the law data applicable to the deferred presentment transaction by the user, a module configured to communicate the results of the comparison (i.e. the compliance status of the transaction) back to the user, and a history module configured to store user session data such as queries, responses and input information to provide a compliance audit trail. The module for providing a source of law data applicable to deferred presentment transactions by the user is configured to provide access to a source of law data, determine and encode requirements from the law data, including, but not limited to, a maximum transaction fee and a number of loans limit. A module for providing a source of law data may include associating law data with a state identifier and storing the law data and state identifier. A module for providing a source of law data may include periodically reviewing the law data. A history table of updates to the law data may be maintained. A module for creating a user account for a user may include receiving and storing lender information input from a user, the lender information including facility identification information. Ownership entity and facility identification information (e.g., the state in which the facility is located) is associated with deferred presentment transaction data for the transaction, thus enabling the governing state law to be determined. The deferred presentment transaction data includes borrower information, a transaction type datum, lender facility location information, a transaction date, a transaction amount, a transaction fee, an agreement date, a due date, a deposit date, a closed date, a return date and other fields as required to effectively ensure that the transaction complies with applicable law, a transaction fee, an agreement date, a due date, a deposit date, a closed date, a return date and other fields as required to effectively ensure that the transaction complies with applicable law. Applicable legal requirements are determined based upon the deferred presentment transaction data, particularly facility location information. A module for automatically comparing the deferred presentment transaction data for the transaction by the user with the law data applicable to the deferred presentment transaction is configured to compare transaction data for the deferred presentment transaction with a maximum legally allowable transaction data, and/or compare a deferred presentment transaction number for a borrower with a maximum legal number of deferred presentment transactions for a borrower, and/or compare the deferred presentment transaction data for the transaction by the user with the law data applicable to the deferred presentment transaction includes comparing a deferred presentment transaction number for a borrower for a determined period of time with a maximum legal number of deferred presentment transactions for a borrower for a determined period of time, and/or if a transaction is determined to be “consecutive” compare the number of consecutive loans with legal limits. By way of example and not limitation, Oklahoma considers a loan conducted within 7 days of closing a prior loan to be consecutive and requires a 48 hour waiting period after the 5th consecutive loan. Thus, compliance assessment entails determining whether a loan is a 6^{th} consecutive loan, and, if so, whether there has been 48 hour wait. A module for approval determination is configured to base a determination upon the comparison of the deferred presentment transaction data for the transaction by the user with the law data applicable to the deferred presentment transaction by the user, with the determination being approved if the deferred presentment transaction data complies with the law data applicable to the deferred presentment transaction and the determination being failed if the deferred presentment transaction data complies with the law data applicable to the deferred presentment transaction.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides a high level block diagram of components of an exemplary regulatory compliance system according to principles of the invention; and

FIG. 2 provides a high level flowchart of steps of an exemplary regulation update process according to principles of the invention; and

FIG. 3 provides a high level flowchart of steps of a user registration process according to principles of the invention; and

FIG. 4 provides a high-level flowchart of steps of a compliance checking process according to principles of the invention.

Those skilled in the art will appreciate that the Figures are not intended to illustrate every implementation of the invention. Specifically, the invention is not limited to the exemplary implementations, system, components, processes, steps or order of steps depicted in the Figures.

### DETAILED DESCRIPTION

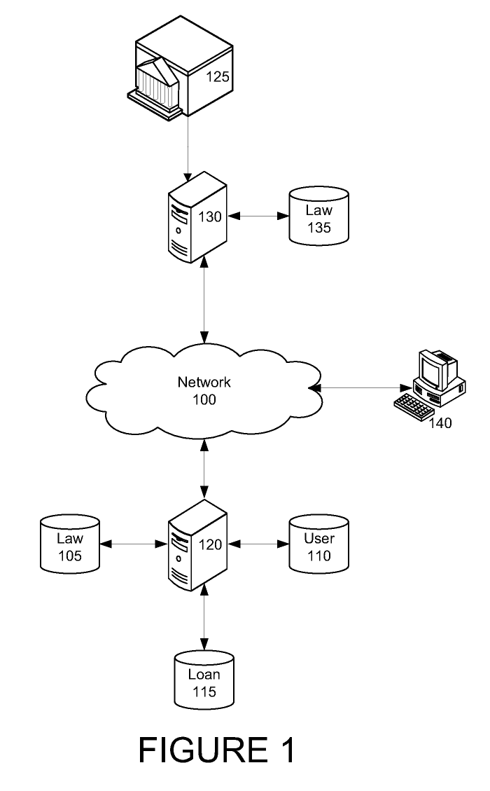

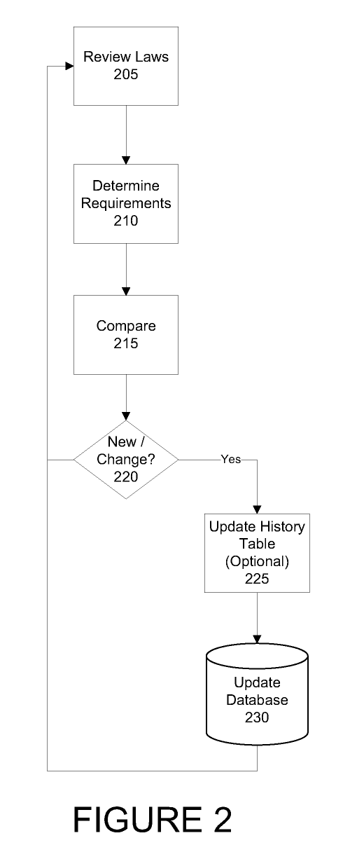

In an exemplary implementation of the invention, an automated system and method for determining whether a transaction complies with then-current applicable laws and regulations, notifying a lender of the outcome of the determination and maintaining a database of transaction information are provided. FIG. 1 provides a high level block diagram of components of an exemplary regulatory compliance system according to principles of the invention. FIGS. 2 through 4 provide high-level flowcharts of exemplary regulation monitoring, user registration, and compliance processes according to principles of the invention.

Referring first to FIG. 1, a high level block diagram of components of an exemplary regulatory compliance system according to principles of the invention is shown. A governing body 125, such as a legislative and executive branch, regulatory agency and/or court establishes, by enactment, promulgation, ruling or otherwise, laws that govern deferred presentment transactions and lenders. The laws may be accessible in a conventional manner, such as in printed form or electronically via a computer 130 and data source 135. The computer 130 may be accessible over a communications network 100.

Optionally, a service provider monitors the laws and maintains a database 105 of codes corresponding to the laws. As used herein, database means a source of data, including any organized body of related information. A server 120 hosts software for storing data and performing functions according to the invention. Users (e.g., lenders) using computing devices 140 access the server 120 to register and determine if a transaction complies with applicable laws. Access to the server 120 by the user 140 is preferably via one or more data communications networks 100, which may include the Internet.

An exemplary server 120 is comprised of one or more computer systems, each having a bus for communicating information, a central processing unit (CPU), a read only memory (ROM), a random access memory (RAM), a mass storage device, and communications equipment. The storage device may include a hard disk, CD-ROM drive, DVD drive, tape drive, memory (e.g., RAM, ROM, Compact Flash RAM, PCMCIA RAM) and/or other storage equipment. An input device such as a keyboard, touch sensitive screen, a pointing device (e.g., a computer mouse, touch pad or joystick) and the like may also be provided. Software such as network operating system software may be stored on and executable on the server. These elements are typically included in many computer servers. Indeed, the aforementioned servers are intended to represent a broad category of computer systems capable of functioning as a computer server and hosting application software for network access and use and database management in accordance with the present invention. Of course, the server 120 may include fewer, different and/or additional elements, functioning as single servers or as a distributed system, provided they are capable of performing functions in accordance with the present invention.

The server 120 hosts (i.e., provides clients with access to) information, documents and software needed to provide functionality and enable performance of methodologies in accordance with an exemplary embodiment of the invention. For example, the server 120 may include web page information and documents (e.g., scripts, HTML and XML code), applets and application software, which manage subscriber access and use, processes transactions and manage databases for subscriber data.

The server 120 may be responsible for accepting HTTP requests from client Web browsers, and serving the requester HTTP responses along with optional data contents, which usually are Web pages such as HTML documents and linked objects (images, etc.). The HTTP response typically consists of an HTML document, but can also be a raw text file, an image, or some other type of script, document, applet, file, message or information. The Web server may have the capability of logging detailed information, about client requests and server responses, to log files, allowing the Webmaster to collect statistics by running log analyzers on log files. Such statistics may be used for security monitoring and to optimize performance.

One or more database servers may be provided to run a database management system (DBMS) which provides functionality, namely, managing and querying the databases 105, 110 and 115. The databases 105, 110 and 115 may be separate or integrated data stores, i.e., structured collections of records or data stored in a computer so that the database management system can consult it to answer queries.

A plurality of users (i.e., lenders) directly or indirectly access the server 120 using compatible computing devices 140 with network connectivity. By way of example, such end-user computing devices 140 may include personal computers, personal digital assistants or any similarly equipped electronic computing devices. Although one user computer 140 is shown for illustrative purposes, any number of user computers may be used in accordance with the invention. Additionally, various forms of network connectivity may be used by the user computers 140 to access the server 120. Subscriber system may include an operating system and a web browser configured to process data sent by the server system.

Those skilled in the art will appreciate that a system according to the invention can utilize many different types of communications networks 100. For example, a proprietary Wide Area Network (WAN) or a public WAN such as the Internet may be used. These networks typically employ various protocols such as the HyperText Transfer Protocol (HTTP), Extensible Markup Language (XML), and Transfer Control Protocol/Internet Protocol (TCP/IP) to communicate information between remote computer systems. A system according to the present invention may also utilize wireless networks, including those utilizing Global System for Mobile (GSM), Code Division Multiple Access (CDMA) or Time Division Multiple Access technology, and the Wireless Application Protocol (WAP). A system according to the invention may utilize any or any combination of, such communications networks and new network technologies hereafter developed.

A firewall may be located between each server 120, 130, and the network 100 to protect against corruption, loss, or misuse of data. The firewall limits access by the user computers 140 and prevents corruption of data. Thus, the user computers 140 may access and receive only data that is deemed necessary and authorized according to firewall settings. The firewall may be integrated within the servers 120, 130 as software, firmware or a hardware component, or constitute another system component, or reside as a standalone component.

The processes, functions and/or algorithms described herein are implemented in hardware, software or a combination of software and hardware in one embodiment. The software comprises computer executable instructions encoded in a computer readable media. Further, such functions correspond to modules, which are software, hardware, firmware, or any combination thereof. Multiple functions are performed in one or more modules as desired, and the embodiments described are merely examples. The software is executed on a digital signal processor, application-specific integrated circuit, microprocessor, or other type of processor operating on a system, such as a personal computer, server, a router, or other device capable of processing data including network interconnection devices. Some embodiments may implement the functions in two or more specific interconnected hardware modules or devices with related control and data signals communicated between and through the modules, or as portions of an application-specific integrated circuit. Thus, the exemplary process flow is applicable to software, firmware, and hardware implementations.

The databases 105-115 contain a comprehensive collection of legal, user and loan data as well as other relevant data arranged, organized, indexed and/or retrievable based on address or other identifying criteria. An administrator of the system acquires the legal data from the legal data source 135. The loan database 115 comprises loan data obtained from user input for each transaction. The user database 110 comprises user (i.e., lender) data obtained from lenders during registration and account maintenance. Each item of data acquired and entered into a database 105-115 is associated with a particular address, geographical region, user, transaction, session or other identifier. When a report is requested as discussed herein, available records indexed by the same address, geographical region or other identifier are selected.

The separate databases are shown for reference convenience to conceptually illustrate three different categories of data. While the databases are conceptually illustrated as three separate distinct databases in the Figures, those skilled in the art will appreciate that two or more of the databases may be combined, included together or separately in a larger database, or further subdivided into smaller component databases. The invention is not limited to any particular data or database structures.

The databases 105-115 may be any conventional database capable of effectively storing collections of records in an organized accessible manner to permit efficient easy access to desired pieces of data, i.e. one or more records, for example, associated with a particular property, using appropriate database management system software. The data may be obtained and updated online or off-line, in real-time or in batch mode.

The exemplary system populates the legal database 105 with legal data. Legislative bodies and legal reporting services (e.g., Westlaw® and Lexis®) maintain public records of statutes, rules, regulations, case law and executive orders pertaining to lenders and deferred presentment transactions, referred to herein as law or applicable law. In most cases, the legal information is available electronically form a data source 135 via a server 130. Such records typically include the reporting, record-keeping and due diligence obligations of lenders, as well as the requirements for a lawful and proper transaction. Data corresponding to such obligations and requirements is determined from the law reporting database 135, entered into the database 105 and associated with a state.

The process for entering/updating a law record starts with reviewing the source of law data 125, 135, e.g., via server 130, as in step 205 of FIG. 2. Before law information is entered into the law database 105, the requirements are determined and encoded, as in step 210 of FIG. 2. By way of example, the database 105 may include a field for record keeping in years, which is a field that indicates how many years a lender must maintain records of a transaction, the value of which may be zero or greater. Other fields may indicate interest rate caps, the number of loans a borrower can take at a single time, the number of loans per borrower per year, etc . . . Yet other fields may indicate reporting requirements in years. The determined encoded data is then compared with existing information in the database for the associated state, as in step 215 of FIG. 2. If the data is new or changed, each field entry that is new or changed may be copied to a history table, as in optional step 225, and then the record is updated as in step 230. Subsequently, control may be passed to step 205 to continue periodic review of the laws. The history table maintains a record of all updates to the legal database, which can be used for compliance checking over a period of time. If the data is not new or changed 220, the database is maintained and control may be passed to step 205 to continue periodic review of the laws.

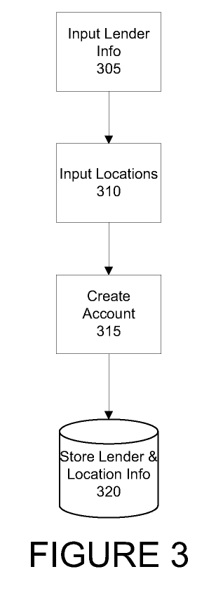

Referring now to FIG. 3, a high level flowchart of steps of a user registration process according to principles of the invention is conceptually shown. The registration process entails receiving lender information (e.g., name, principal address, contact information) input by a user (e.g., lender), as in step 305. Other information (e.g., billing information) may be also be required. Location information for each facility of the lender is provided, as in step 310. The system then creates an account for the lender, as in step 315. The account information, including the lender and facility information, is stored in a user database 110, as in step 320. Online login and update tools may be provided to allow lenders password protected access to their account information, for purposes of updating their account. Thus, the system stores lender and facility information, which can be associated with each transaction.

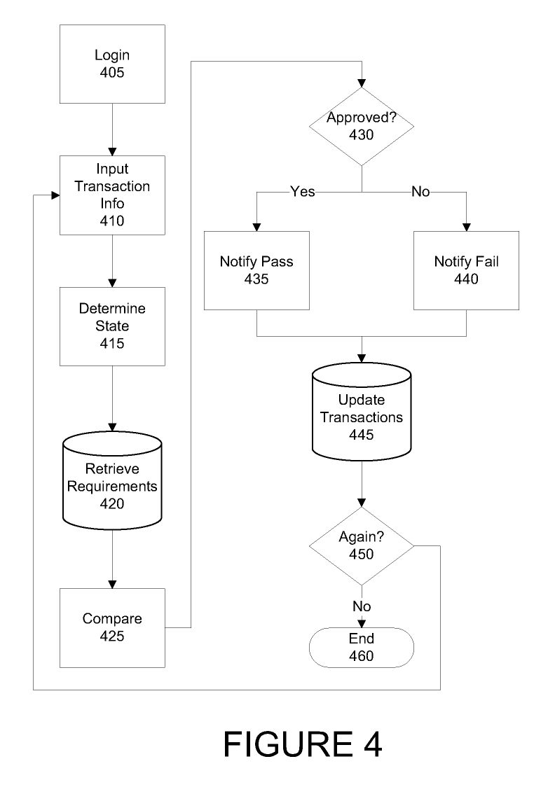

FIG. 4 provides a high-level flowchart of steps of a compliance checking process according to principles of the invention. The process entails logging in, preferably through a password protected interface, as in step 405. Logging in serves to identify the user, facility and company, while preventing access by unauthorized entities and users. After logging in, transaction information is entered, as in step 410. The transaction information includes borrower information, the type of transaction, the facility from which the transaction is being processed, the date, the amount of the transaction, the interest rate, all fees associated with the transaction, and any other relevant information. Based upon the input information, the state and applicable legal requirements may be determined, as in steps 415 and 420. Then the requirements are compared with the transaction information to assess compliance, as in step 425. By way of example, the interest rate may be compared with interest rate caps, the number of loans for the borrower may be determined from the transaction database and/or user input and compared with the number of loans a borrower can take at a single time under applicable law, the number of loans for the borrower may be determined from the transaction database and/or user input and compared with the number of loans for that borrower over the past determined period of time (e.g., year), etc . . . Based upon the comparisons, an approval determination is made, as in step 430. If the input data and previously stored data reveal no conflict with the legal requirements, the transaction may be approved and a notification of approval may be communicated to the user 140, as in step 435. If the input data and previously stored data reveal a conflict with the legal requirements, the transaction may be flagged and a notification of failure may be communicated to the user 140, as in step 440. The failure notification may explain the reason for failure. Subsequently, the transaction database is updated with the transaction information, lender information for the transaction and approval decision, as in step 445. The process may be repeated for additional transactions, as in step 450, and several transactions by one or more users may be processed simultaneously. If there are no additional transactions, the process may end and the user may logoff for the current session, as in step 460.

Reporting tools may be provided to allow users to interactively interrogate the database, analyze its data and update it according to the user's privileges on data. The reporting tools may also allow the user to custom-design reports. A report can be previewed on a screen, printed onto paper or exported to one of several different file formats such as, for example, PDF, Microsoft® Excel, text or CSV. Report formats can vary from a simple column of values to layouts featuring pie charts, bar charts, cross-tab summary tables and nested sub-reports.

Customer service functions, steps and modules may be provided to ensure quality of service delivery for consumers and lenders by providing ready multi-lingual (e.g. English and Spanish) access to information, education, and issue resolution. Preferably highly qualified technical support and help desk support is available to respond within a determined service level to address any issues, monitor the system and provide several levels of support as required to maintain a secure and reliable processing environment. An interactive voice response unit available 24×7 may be provided as an integral part of the call center infrastructure to enables lenders and customers to access information and conduct business around the clock.

In sum, an exemplary computer-implemented system for deferred presentment transaction legal compliance according to principles of the invention includes a module for creating a user account for a user; a module for providing a source of law data applicable to deferred presentment transactions by the user; a module for receiving deferred presentment transaction data for a transaction by the user; a module for automatically comparing the deferred presentment transaction data for the transaction by the user with the law data applicable to the deferred presentment transaction by the user; and a module for determining whether the deferred presentment transaction data for the transaction by the user complies with the law data applicable to the deferred presentment transaction by the user. The a module for providing a source of law data applicable to deferred presentment transactions by the user is configured to provide access to a source of law data, determine and encode requirements from the law data, including a transaction fee limit and a number of loans limit. A module for providing a source of law data may include associating law data with a state identifier and storing the law data and state identifier. A module for providing a source of law data may include periodically reviewing the law data. A history table of updates to the law data may be maintained. A module for creating a user account for a user may include receiving and storing lender information input from a user, the lender information including facility identification information. Ownership entity and facility identification information (e.g., the state(s) in which the entity and facility are located) is associated with deferred presentment transaction data for the transaction, thus enabling the governing state law to be determined. The deferred presentment transaction data includes borrower information, a transaction type datum, owner entity information, lender facility location information, a transaction date, a transaction amount, a transaction fee, an agreement date, a due date, a deposit date, a closed date, a return date and other fields as required to effectively ensure that the transaction complies with applicable law. Applicable legal requirements are determined based upon the deferred presentment transaction data, particularly facility location information. A module for automatically comparing the deferred presentment transaction data for the transaction by the user with the law data applicable to the deferred presentment transaction is configured to compare transaction data for the deferred presentment transaction with maximum legally allowable transaction data, and/or compare a deferred presentment transaction number for a borrower with a maximum legal number of deferred presentment transactions for a borrower, and/or compare the deferred presentment transaction data for the transaction by the user with the law data applicable to the deferred presentment transaction includes comparing a deferred presentment transaction number for a borrower for a determined period of time with a maximum legal number of deferred presentment transactions for a borrower for a determined period of time. A module for approval determination is configured to base a determination upon the comparison of the deferred presentment transaction data for the transaction by the user with the law data applicable to the deferred presentment transaction by the user, with the determination being approved if the deferred presentment transaction data complies with the law data applicable to the deferred presentment transaction and the determination being failed if the deferred presentment transaction data complies with the law data applicable to the deferred presentment transaction.

Likewise, in sum, an exemplary computer-implemented method for deferred presentment transaction legal compliance according to principles of the invention includes creating a user account for a user; providing a source of law data applicable to deferred presentment transactions by the user; receiving deferred presentment transaction data for a transaction by the user; automatically comparing the deferred presentment transaction data for the transaction by the user with the law data applicable to the deferred presentment transaction by the user; and determining whether the deferred presentment transaction data for the transaction by the user complies with the law data applicable to the deferred presentment transaction by the user. The step of providing a source of law data applicable to deferred presentment transactions by the user may include reviewing a source of law data, determining and encoding requirements from the law data, including, for example, a transaction fee limit and a number of loans limit. The step of providing a source of law data may include associating law data with a state identifier and storing the law data and state identifier. The step of providing a source of law data may include periodically reviewing the law data. A history table of updates to the law data may be maintained. The step of creating a user account for a user may include receiving and storing lender information input from a user, the lender information including facility identification information. Ownership entity and facility identification information (e.g., the state in which the facility is located) is associated with deferred presentment transaction data for the transaction, thus enabling the governing state law to be determined. The deferred presentment transaction data includes borrower information, a transaction type datum, owner entity information, lender facility location information, a transaction date, a transaction amount, a transaction fee, an agreement date, a due date, a deposit date, a closed date, a return date and other fields as required to effectively ensure that the transaction complies with applicable law. Applicable legal requirements are determined based upon the deferred presentment transaction data, particularly facility location information. The step of automatically comparing the deferred presentment transaction data for the transaction by the user with the law data applicable to the deferred presentment transaction includes comparing transaction data for the deferred presentment transaction with maximum legally allowable transaction data, and/or comparing a deferred presentment transaction number for a borrower with a maximum legal number of deferred presentment transactions for a borrower, and/or comparing the deferred presentment transaction data for the transaction by the user with the law data applicable to the deferred presentment transaction includes comparing a deferred presentment transaction number for a borrower for a determined period of time with a maximum legal number of deferred presentment transactions for a borrower for a determined period of time. An approval determination is based upon the comparison of the deferred presentment transaction data for the transaction by the user with the law data applicable to the deferred presentment transaction by the user, with the determination being approved if the deferred presentment transaction data complies with the law data applicable to the deferred presentment transaction and the determination being failed if the deferred presentment transaction data complies with the law data applicable to the deferred presentment transaction.

While the invention has been described in terms of various embodiments and implementations, those skilled in the art will recognize that the invention can be practiced with modification within the spirit and scope of the appended claims. The invention is not limited to the exemplary steps and components described above. The selection, arrangement and configuration of components, and the selection and order of steps may be varied within the scope of the invention.

What is claimed is:

1. A computer-implemented method for deferred presentment transaction legal compliance, said method comprising:
creating a user account for a user;
providing a source of law data applicable to deferred presentment transactions by the user;
receiving deferred presentment transaction data for a transaction by the user;
automatically comparing the deferred presentment transaction data for the transaction by the user with the law data applicable to the deferred presentment transaction by the user;
determining whether the deferred presentment transaction data for the transaction by the user complies with the law data applicable to the deferred presentment transaction by the user; and
transmitting a response to the user indicating the compliance status of the transaction.

2. A computer-implemented method for deferred presentment transaction legal compliance according to claim 1, wherein the step of providing a source of law data applicable to deferred presentment transactions by the user comprises reviewing a source of law data.

3. A computer-implemented method for deferred presentment transaction legal compliance according to claim 2, wherein the step of providing a source of law data applicable to deferred presentment transactions by the user comprises determining and encoding requirements from the law data, said requirements including a transaction fee limit.

4. A computer-implemented method for deferred presentment transaction legal compliance according to claim 3, wherein the step of providing a source of law data applicable to deferred presentment transactions by the user comprises determining and encoding requirements from the law data, said requirements including a number of loans limit.

5. A computer-implemented method for deferred presentment transaction legal compliance according to claim 4, wherein the step of providing a source of law data comprises associating law data with a state identifier and storing the law data and state identifier.

6. A computer-implemented method for deferred presentment transaction legal compliance according to claim 5, wherein the step of providing a source of law data comprises periodically reviewing the law data.

7. A computer-implemented method for deferred presentment transaction legal compliance according to claim 6, further comprising maintaining a history table of updates to the law data.

8. A computer-implemented method for deferred presentment transaction legal compliance according to claim 7, wherein the step of creating a user account for a user comprises receiving and storing lender information input from a user, the lender information including facility identification information.

9. A computer-implemented method for deferred presentment transaction legal compliance according to claim 8, further comprising associating ownership entity and facility identification information with deferred presentment transaction data for the transaction.

10. A computer-implemented method for deferred presentment transaction legal compliance according to claim 1, wherein the deferred presentment transaction data includes borrower information, a transaction type datum, owner entity information, lender facility location information, a transaction date, a transaction amount, a transaction fee, an agreement date, a due date, a deposit date, a closed date, and a return date.

11. A computer-implemented method for deferred presentment transaction legal compliance according to claim 10, determining applicable legal requirements based upon the deferred presentment transaction data.

12. A computer-implemented method for deferred presentment transaction legal compliance according to claim 10, determining applicable legal requirements based upon the lender facility location information.

13. A computer-implemented method for deferred presentment transaction legal compliance according to claim 1, wherein the step of automatically comparing the deferred presentment transaction data for the transaction by the user with the law data applicable to the deferred presentment transaction includes comparing a transaction fee for the deferred presentment transaction with a maximum legal transaction fee.

14. A computer-implemented method for deferred presentment transaction legal compliance according to claim 1, wherein the step of automatically comparing the deferred presentment transaction data for the transaction by the user with the law data applicable to the deferred presentment transaction includes comparing a deferred presentment transaction number for a borrower with a maximum legal number of deferred presentment transactions for a borrower.

15. A computer-implemented method for deferred presentment transaction legal compliance according to claim 1, wherein the step of automatically comparing the deferred presentment transaction data for the transaction by the user with the law data applicable to the deferred presentment transaction includes comparing a deferred presentment transaction number for a borrower for a determined period of time with a maximum legal number of deferred presentment transactions for a borrower for a determined period of time.

16. A computer-implemented method for deferred presentment transaction legal compliance according to claim 1, wherein the step of automatically comparing the deferred presentment transaction data for the transaction by the user with the law data applicable to the deferred presentment transaction includes comparing a deferred presentment transaction number for a borrower with a maximum legal number of deferred presentment transactions for a borrower, and comparing the deferred presentment transaction data for the transaction by the user with the law data applicable to the deferred presentment transaction includes comparing a deferred presentment transaction number for a borrower with a maximum legal number of deferred presentment transactions for a borrower, and comparing the deferred presentment transaction data for the transaction by the user with the law data applicable to the deferred presentment transaction includes comparing a transaction fee for the deferred presentment transaction with a maximum legal transaction fee.

17. A computer-implemented method for deferred presentment transaction legal compliance according to claim 1, further comprising making an approval determination based upon the comparison of the deferred presentment transaction data for the transaction by the user with the law data applicable to the deferred presentment transaction by the user.

18. A computer-implemented method for deferred presentment transaction legal compliance according to claim 1, further comprising making an approval determination of approved or failed based upon the step of automatically comparing the deferred presentment transaction data for the transaction by the user with the law data applicable to the deferred presentment transaction by the user, with the determination being approved if the deferred presentment transaction data complies with the law data applicable to the deferred presentment transaction.

19. A computer-implemented method for deferred presentment transaction legal compliance according to claim 1, further comprising making an approval determination of approved or failed based upon the step of automatically comparing the deferred presentment transaction data for the transaction by the user with the law data applicable to the deferred presentment transaction by the user, with the determination being failed if the deferred presentment transaction data complies with the law data applicable to the deferred presentment transaction.

20. A computer-implemented method for deferred presentment transaction legal compliance according to claim 1, further comprising making an approval determination of approved or failed based upon the step of automatically comparing the deferred presentment transaction data for the transaction by the user with the law data applicable to the deferred presentment transaction by the user, and providing a notice of the determination to the user.
